(19) United States
(12) Patent Application Publication
(10) Pub. No.: US 2003/0039886 A1
(43) Pub. Date: Feb. 27, 2003

(54) Modified lithium ion polymer battery

(76) Inventors: Guiping Zhang, Shenzhen (CN); Yongyang Yu, Shenzhen (CN); Torng Jinn Lee, Jubei City (TW)

Correspondence Address: RABIN & BERDO, P.C., Suite 500, 1101 14th Street, N.W., Washington, DC, 20005, US

(21) Appl. No.: 09/933,838

(22) Filed: Aug. 22, 2001

(51) Int. Cl. H01M 4/62; H01M 4/50; H01M 4/52; H01M 10/40

(52) U.S. Cl. 429/217; 429/317; 429/316; 429/231.1; 429/231.3; 429/223; 429/224; 429/231.8; 429/338; 429/342

(57) ABSTRACT

A modified lithium ion polymer battery, comprising a positive electrode sheet and a negative electrode sheet, formed by blending a binder with positive electrode powder and coating the resulting blend on a copper foil or an aluminum foil used as the collector, wherein said binder can be prepared from the following three components: (a) 0.1 wt %˜95 wt % of polyvinylidene fluoride; (b) 0.1 wt %˜90 wt % of a modified polyacrylates; and (c) 0.1 wt %˜85 wt % of a modified polyethylene or polydienes; alone, or from any two or all of them in a proper ratio; and a separation membrane, which is a non-porous polyalkylene oxide film or a film made by coating a blend of polyalkylene oxide and polyvinylidene fluoride (PVDF), or a micro-porous polypropylene film, or a three-layered composite film of polypropylene/polyethylene/polypropylene; wherein said positive and negative electrode sheets are laminated with said separation membrane to form a overlap sheet or roll in a alternative and isolation manner; said positive and negative collectors are welded, respectively; and the whole laminate is assembled with an aluminum plastic membrane to form said lithium ion polymer battery.

### BACKGROUND OF THE INVENTION

1. Field of the Invention

The invention relates to a modified lithium ion polymer battery comprising of a positive electrode sheet, a negative electrode and a separating membrane, wherein said positive and negative electrodes are formed by blending positive and negative electrode powders with a modified binder and coating the resulting mixture on copper or aluminum foil collectors, and wherein said battery is fabricated by winding said positive and negative electrode sheets with said separating membrane laminated therebetween into a roll, and then welding and processing with positive and negative collectors, respectively.

2. Description of the Prior Art

U.S. Pat. No. 5,296,318 disclosed a lithium polymer battery based on Bellcore, wherein its collectors were made of copper and aluminum sieves, and a copolymer of polyvinylidene fluoride and hexafluoropropylene was used as the binder. Although such binder exhibited better binding power, but binding poorly to copper and aluminum foils. This was why said polymer battery adopted copper or aluminum sieves as collectors. Under such circumstance, the binder could penetrate meshes of those sieves and adhered themselves as well as the copper/aluminum sieves to form positive and negative electrode sheets, respectively. In order to impart the binder a self-adhesion, during heat rolling in the processing, a plasticizer (DBP, dibutyl phthalate) must be incorporated into the binder such that the binder could be blended with the positive or negative electrode powders and thereby could be coated into a film, otherwise, the film could not be processed and bonded (through heat lamination) with said copper/aluminum sieves. Further, because of the incorporation of the plasticizer, the battery must undergo an extraction step to remove the plasticizer. This resulted into several disadvantages as rendering the fabricating of the battery a complicated process, increasing the cost of the production, and incomplete removal of the plasticizer.

In order to overcome the above-mentioned disadvantages, the invention provides a modified lithium ion polymer battery based essentially on the modification of the binder, and then application of the binder on the positive and negative electrode sheets, as well as in combination with a separation membrane laminated between said positive and negative electrode sheets, characterized in that no plasticizer is necessary to be incorporated in the modified lithium ion polymer battery according to the invention, and hence any extraction step can be omitted, and that a copper/aluminum foils is used in stead of copper/aluminum sieves as the collector.

### SUMMARY OF THE INVENTION

Accordingly, the invention provides a modified lithium ion polymer battery comprising of a positive electrode sheet, a negative electrode and a separating membrane, wherein said positive and negative electrodes are formed by blending positive and negative electrode powders with a modified binder and coating the resulting mixture on copper or aluminum foil collectors, and wherein said battery is fabricated by winding said positive and negative electrode sheets with said separating membrane laminated therebetween into a roll, and then welding and processing with positive and negative collectors, respectively.

In particular, the invention provides an above-described modified lithium ion polymer battery, characterized in that the binder used can absorb an amount of electrolyte and thereby can form a colloid that exhibits an excellent high low-temperature characteristics (Tg:−40° C.; heat cracking temperature: 300° C.), that the binder shows good adhesion against the copper/aluminum foils such that it will not be affected by the electrolyte and no dislodging of active positive/negative substance from the collectors will occur, and that the binder can impart said positive and negative electrode sheets a superior flexibility.

The lithium ion polymer battery according to the invention exhibits following characteristics:

(1) The battery has a high capacity and high density.

(2) The battery possesses a long cyclic life and small internal resistance.

(3) The battery can be used in a wide suitable range of temperatures.

(4) The battery shows a high safety (non-explosive and un-ignitable).

(5) Blending, coating and laminating can be accomplished under normal moist (very low moisture) environment.

(6) Heat lamination is omitted in the process according to the invention.

(7) The battery according to the invention has a high rate of discharging ability and low self-discharging property.

### BRIEF DESCRIPTION OF THE DRAWINGS

The invention, as well as its many advantages, may be further understood by the following detailed description and drawings in which:

FIG. 1 is a schematic view showing the alternative arrangement of the positive and negative electrode with separating membrane laminated therebetween, wherein: a, the positive electrode sheet; b, the negative electrode sheet; and c, the separating membrane.

### DETAILED DESCRIPTION OF THE PREFERRED EMBODIMENT

As described above, the invention provides a modified lithium ion polymer battery and a process for fabricating the same. In one aspect, the modified lithium ion polymer battery according to the invention comprises a positive electrode sheet a, a negative electrode sheet b, and a separation membrane c, wherein said positive and negative electrode sheets a and b are formed by using a binder that can be prepared from the following three components:

(a) 0.5 wt %˜95 wt % of polyvinylidene fluoride;

(b) 1 wt %˜90 wt % of a modified polyacrylates, is a substance made by co-polymerizing more than 60 wt % of a carboxylic acid or carboxylic acid ester as the major constituent selected from a group consisting of acrylonitrile,2-ethylhexyl acrylate,acrylic acid, methacrylic acid, methyl acrylate, methyl methacrylate, ethyl acrylate, butyl acrylate, butyl methacrylate, ethyl acrylate, propyl acrylate, acrylamide, vinyl acetate, dodecyl acrylate, octadecyl acrylate, hydroxyethyl acrylate, hydroxypropyl acrylate, itaconic acid and the like; and 0˜40 wt % of a second constituent selected from styrene and butadiene, into a copolymer, and subsequently neutralizing part or all of the carboxylic groups on said copolymer;

(c) 0.5 wt %˜85 wt % of a modified polyethylene or polydienes;

Alone, or from any two of them in a proper ratio, or all of these three components in a proper ratio. Said binder system exhibits an excellent high/low temperature characteristics (Tg:−40° C.; heat cracking temperature: 300° C.), and can absorb an amount of electrolyte to form a colloid that shows good conductivity of lithium ion. Further, during the fabrication of the battery, said binder can impart said positive/negative electrode sheet a superior flexibility.

The separating membrane used in the modified lithium ion polymer battery according to the invention can be selected from the group consisting of:

(1) A nonporous polyalkylene oxide film.

(2) A film formed by blending and then coating polyalkylene oxide and polyvinylidene fluoride.

(3) A film formed by blending and then coating polyacrylates and polyvinylidene fluoride.

(4) A microporous polypropylene film.

(5) A microporous three-layered polypropylene/polyethylene/polypropylene composite film.

In fabrication of the modified lithium ion polymer battery according to the invention, the above-described binder system is blended with the positive or negative powder at first, and the resulted mixture is coated as slurry or compressed as powder or rolled over copper/aluminum foils used as the collector, and thereby forms a positive electrode sheet and a negative electrode sheet. The above process can be done under low temperature/low moisture.

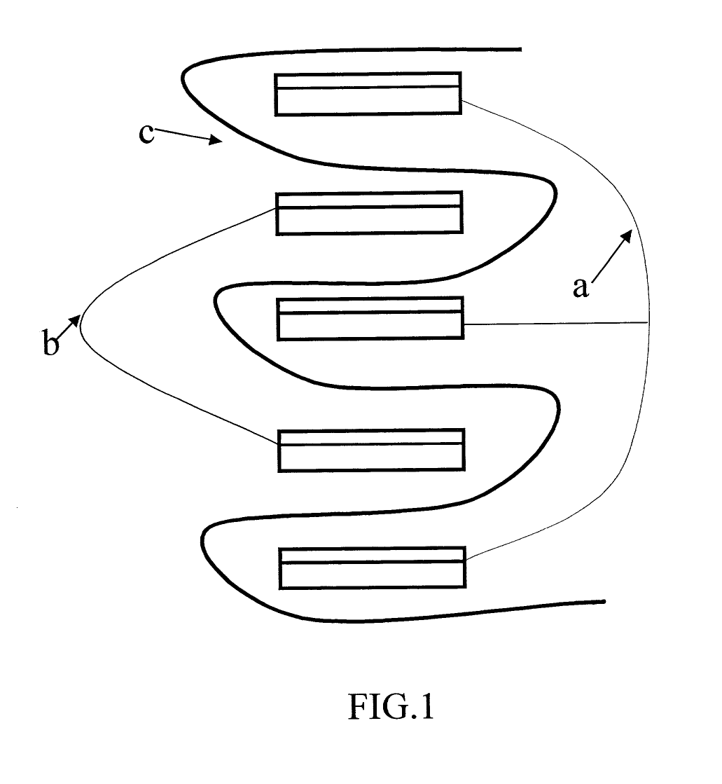

As shown in FIG. 1, in one embodiment, the modified lithium ion polymer battery according to the invention comprises a positive electrode sheet a, a negative electrode sheet b, and a separation membrane c that form a overlap/roll in a alternative and isolation manner as an positive electrode sheet a/negative electrode sheet b/separation membrane c. Then, electrode leads from positive and negative electrode sheets a and b are welded together, respectively. The thus-welded electrode leads are then welded with the positive and negative contacts out of the battery, respectively, without heat lamination. Thereafter, the positive or negative electrode sheets a or b is welded together. An aluminum plastic film is used to pre-sealing over three sides and then the electrolyte is poured in. Finally, the last side is sealed and the whole battery is aged, evacuated and secondary sealed to yield the modified lithium ion polymer battery.

The active material used in the positive electrode of the modified lithium ion polymer battery according to the invention is a composite oxide of lithium and transition metals, such as LiCoO₂, LiMn₂O₄, LiNiO₂, LiNiₓCo₁₋ₓO₂ and the like. The active materials used in the negative electrode of the modified lithium ion polymer battery according to the invention is carbon powder, such as mesophase carbon micro-beads (MCMB), natural graphite and modified products thereof, petroleum coke and modified products thereof, as well as hard carbon materials.

The electrolyte used in the modified lithium ion polymer battery according to the invention comprises:

(1) 3 wt˜12 wt % of lithium salts selected from the group consisting of LiPF₆, LiAsF₆, LiCIO₄, LiN(CF₃SO₂)₂, LiBF₄, LiSbF₆, LiCF₃SO₃ and the like;

(2) 25wt˜60wt % of organic solvent such as ethylene carbonate, propylene carbonate, dimethyl carbonate, diethoxyethane, diethyl carbonate, dimethoxyethane, dipropyl carbonate and the like; and

(3) 15wt˜40wt % of a copolymer; wherein the concentration of said lithium salt in said solvent is 0.1˜2 M. The invention will be further illustrated in more detailed by way of the following non-limiting examples. Modification and changes thereto as can be readily done by persons skilled in the art are intended to be encompassed in the scope of the invention.

### EXAMPLE 1

To a stainless steel can was charged 2 wt % of polyvinylidene fluoride, 2 wt % of modified polyethylene, 96 wt % of carbon powder and 40 wt % of N-methyl pyrrolidone. The resulting mixture was mixed in a high speed mixer into a homogeneous slurry. The slurry was then used to coat over a copper foil used as the collector. The coated copper foil was dried in an oven at 100° C.˜200° C. to form a negative electrode sheet which was cut into desired size.

### EXAMPLE 2

Following the procedure as described in Example 1, to a stainless steel can was charged 2 wt % of polyvinylidene fluoride, 1 wt % of polyacrylate, 7 wt % of conductive carbon black such as acetylene black, 90 wt % of lithium cobaltate and 40 wt % of N-methyl pyrrolidone. The resulting mixture was mixed in a high speed mixer into a homogeneous slurry. The slurry was then used to coat over an aluminum foil used as the collector. The coated foil was dried in an oven at 150° C.˜200° C. to form a positive electrode sheet which was cut into desired size.

### EXAMPLE 3

Following the procedure as described in Example 1, to a stainless steel can was charged 1 wt % of polyacrylate, 1 wt % of modified polyethylene, 6 wt % of conductive carbon black, 92 wt % of lithium cobaltate and 35 wt % of N-methyl pyrrolidone. The resulting mixture was mixed in a high speed mixer into a homogeneous slurry. The slurry was then used to coat over an aluminum foil used as the collector. The coated foil was dried in an oven at 180° C.˜200° C. to form a positive electrode sheet which was cut into desired size.

### EXAMPLE 4

Following the procedure as described in Example 1, to a stainless steel can was charged 1.8 wt % of polyvinylidene fluoride, 0.48 wt % of polyacrylate, 0.5 wt % of modified polyethylene, 7.5 wt % of conductive carbon black, 89.72 wt % of lithium cobaltic acid and 45 wt % of N-methyl pyrrolidone. The resulting mixture was mixed in a high speed mixer into a homogeneous slurry. The slurry was then used to coat over a aluminum foil used as the collector. The coated foil was dried in an oven at 180° C.˜200° C. to form a positive electrode sheet which was cut into desired size.

### EXAMPLE 5

To a stainless steel can was charged 3.5 wt % of modified polyethylene, 96.5 wt % of carbon powder and 95 wt % of N-methyl pyrrolidone. The resulting mixture was mixed in a high speed mixer into a homogeneous slurry. The slurry was then used to coat over a copper foil used as the collector. The coated copper foil was dried in an oven at 200° C. to form a positive electrode sheet that was cut into desired size.

### EXAMPLE 6

A laminate was formed from the positive electrode sheet a consisted of 3.5 wt % of modified polyethylene and 96.5 wt % of carbon powder prepared as in Example 5, the negative electrode sheet b consisted of 2 wt % of polyvinylidene fluoride, 2 wt % of modified polyethylene and 96 wt % of carbon powder prepared as in Example 1, and a separation membrane consisted of a blend of non-porous polyethylene oxide and polyvinylidene fluoride.

### Comparative Example 1

The 700 mAh lithium polymer battery according to the invention as prepared in the above Example 6 was compared with a similar lithium polymer battery prepared by the above-mentioned Bellcore technique as follows:

| | Internal | | Capacity | Capactity | |
|---|---|---|---|---|---|
| Type of | resistance | Capacity | at −20° C. | after 4 hr at | Puncturing the battery with a |
| battery | (mΩ) | mAh | mAh | 90° C., mAh | nail of 2 mm diameter |
| The invention | 28 | 700 | 410 | 680 | Elevation of the battery |
| | | | | | temperature, no ignition, no |
| | | | | | explosion |
| Bellcore | 50 | 540 | 40 | 0 | Temperature elevation, |
| | | | | | smoke evolution |

Accordingly, the invention provides a modified lithium ion polymer battery that has a high capacity, a high density, a long cycle life, a small internal resistance, a wide suitable temperature range, a high discharging capability, a low self-discharging property and high safety.

What is claimed is:

1. A modified lithium ion polymer battery, comprising a positive electrode sheet a, a negative electrode sheet b, and a separation membrane c, wherein said positive and negative electrode sheets a and b are formed by blending a binder with positive electrode powder and coating the resulting blend on a copper foil or an aluminum foil used as the collector, wherein said binder can be prepared from the following three components:
(a) 0.5 wt %˜95 wt % of polyvinylidene fluoride;
(b) 0.1 wt %˜90 wt % of a modified polyacrylates;
(c) 0.1 wt %˜85 wt % of a modified polyethylene or polydienes;
alone, or from any two of them in a proper ratio, or all of these three components in a proper ratio; wherein said positive and negative electrode sheets are laminated with a separation membrane to form a overlap sheet or roll in a alternative and isolation manner; said positive and negative collectors are welded, respectively; and the whole laminate is assembled with an aluminum plastic membrane.

2. A polymer battery as in claim 1, wherein said separation membrane is a non-porous polyalkylene oxide film or a film made by coating a blend of polyalkylene oxide and polyvinylidene fluoride (PVDF), or a micro-porous polypropylene film, or a three-layered composite film of polypropylene/polyethylene/polypropylene.

3. A polymer battery as in claim 2, wherein said separation membrane is produced from polymethyl methacrylate and polyvinylidene fluoride.

4. A polymer battery as in claim 1, wherein said modified polyacrylates is a substance made by co-polymerizing more than 60 wt % of a carboxylic acid or carboxylic acid ester as the major constituent selected from a group consisting of acrylonitrile, 2-ethylhexyl acrylate, acrylic acid, methacrylic acid, methyl acrylate, methyl methacrylate, ethyl acrylate, butyl acrylate, butyl methacrylate, ethyl acrylate, propyl acrylate, acrylamide, vinyl acetate, dodecyl acrylate, octadecyl acrylate, hydroxyethyl acrylate, hydroxypropyl acrylate, itaconic acid and the like; and 0˜40 wt % of a second constituent selected from styrene and butadiene, into a copolymer, and subsequently neutralizing part or all of the carboxylic groups on said copolymer.

5. A polymer battery as in claim 1, wherein said active material used in the positive electrode of the modified lithium ion polymer battery according to the invention is a composite oxide of lithium and transition metals, such as LiCoO₂, LiMn₂O₄, LiNiO₂, LiNiₓCo₁₋ₓO₂ and the like; and the active materials used in the negative electrode of the modified lithium ion polymer battery according to the invention is carbon powder, such as mesophase carbon micro-beads (MCMB), natural graphite and modified products thereof, petroleum coke and modified products thereof, as well as hard carbon materials.

6. A polymer battery as in claim 1, wherein said electrolyte is prepared by mixing a lithium salt selected from the group consisting of LiPF₆, LiAsF₆, LiClO₄, LiN(CF₃SO₂)₂, LiBF₄, LiSbF₆, LiCF₃SO₃ and the like; an organic solvent selected from the group consisting of ethylene carbonate, propylene carbonate, dimethyl carbonate, diethoxyethane, diethyl carbonate, dimethoxyethane, dipropyl carbonate and the like; and a co-polymer.

7. A polymer battery as in claim 6, wherein the concentration of said lithium salt in said electrolyte is 0.1˜2 M.
